(19) United States
(12) Patent Application Publication
(10) Pub. No.: US 2011/0239231 A1
(43) Pub. Date: Sep. 29, 2011

(54) MIGRATING ELECTRONIC DOCUMENT VERSION CONTENTS AND VERSION METADATA AS A COLLECTION WITH A SINGLE OPERATION

(75) Inventors: Jay A. Brown, Long Beach, CA (US); Thomas J. Watson, Riverside, CA (US)

(73) Assignee: INTERNATIONAL BUSINESS MACHINES CORPORATION, Armonk, NY (US)

(21) Appl. No.: 12/730,109

(22) Filed: Mar. 23, 2010

(51) Int. Cl. G06F 9/54

(52) U.S. Cl. 719/328; 719/330

(57) ABSTRACT

Provided are techniques for identifying an electronic document having at least two document versions to be migrated, copying document version contents and version metadata of each of the at least two document versions into a collection for transmission to a destination electronic repository, and sending the collection using a migration Application Programming Interface (API) call to the destination electronic repository with a single operation.

### BACKGROUND

1. Field

Embodiments of the invention relate to migrating electronic document version contents and version metadata as a collection with a single operation.

2. Description of the Related Art

A document version history for an electronic document may be described as a set of document version contents and version metadata for each of the document versions. It is sometimes useful to store multiple (e.g., at least two) versions of an electronic document (referred to herein as “document” for ease of reference). For example, for a particular document, there may be three versions (e.g., Version1, Version2, and Version3). In addition to the contents of the three document versions, version metadata for each of the document versions is also stored (e.g., VersionMetaData1, VersionMetaData2, and VersionMetadata3). The version meta data describes information about the contents of the version, such as, but not limited to: title owner, author, date created, date of most recent modification, format of contents (e.g., word processing document, spreadsheet, etc.), “type” of contents (e.g., invoice, inter-office memo, etc.). In some cases, the multiple document versions are migrated (i.e., copied) from a first type of electronic repository to a second type of electronic repository.

An electronic repository may be described as a computing system that stores data, such as a file system, a Relational DataBase Management System (RDBMS), a document management system or a Content Management System (CMS). A CMS may be described as a system for collaborating on the creation and maintenance of documents and other contents. A CMS is often associated with publishing web-sites, although CMS is not strictly limited to this use.

With conventional migration techniques, there is a bottleneck to processing the migration of document version histories (i.e., document version contents and version metadata) from the first type of electronic repository to the second type of electronic repository. This type of processing commonly occurs when a user's needs have outgrown the capacity or capabilities of the first type of electronic repository currently in use. FIG. 1 illustrates sample code 100 for processing this type of migration in accordance with the prior art. With reference to the code in FIG. 1, if three document versions (e.g., Version1, Version2, and Version3) are being migrated, then, the new document on the second type of electronic repository stores the three document version contents and their version metadata. The second type of electronic repository may store the document version contents and the version metadata together or separately. The second type of electronic repository has a way of retrieving or viewing the document version contents and version metadata separately and has some organization technique to link the document version contents and version metadata together, like a document version history.

In certain embodiments, the operations described in FIG. 1 involve operations between the first electronic repository and the second electronic repository, where each operation involves a distinct Remote Procedure Call (RPC) and the associated network traffic burden. In certain embodiments, the operations between the first electronic repository and the second electronic repository occur over a network. In certain embodiments, the first electronic repository and the second electronic repository are managed by one system and the operations are between two processes.

For example, for three document versions (e.g., Version1, Version2, and Version3), the following processing occurs: 1) the new document is checked out, the contents and the version metadata of Version1 is copied to the new document, and the new document is checked in; 2) the new document is checked out, the contents and the version metadata of Version2 is copied to the new document, and the new document is checked in; and 3) the new document is checked out, the contents and the version metadata of Version3 is copied to the new document, and the new document is checked in.

This is an inefficient migration technique. Thus, there is a need for migrating electronic document version contents and version metadata as a collection with a single operation.

### BRIEF SUMMARY

Provided are a method, computer program product, and system for identifying an electronic document having at least two document versions to be migrated, copying document version contents and version metadata of each of the at least two document versions into a collection for transmission to a destination electronic repository, and sending the collection using a migration Application Programming Interface (API) call to the destination electronic repository with a single operation.

### BRIEF DESCRIPTION OF THE SEVERAL VIEWS OF THE DRAWINGS

Referring now to the drawings in which like reference numbers represent corresponding parts throughout:

FIG. 1 illustrates sample code for processing this type of migration in accordance with the prior art.

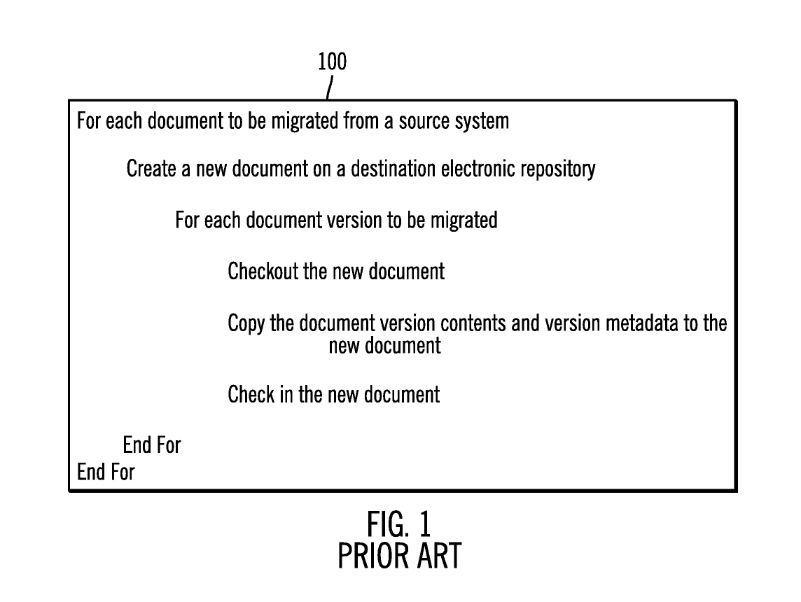

FIG. 2 illustrates a computing architecture in accordance with certain embodiments.

FIG. 3 illustrates another computing architecture in accordance with certain embodiments.

FIG. 4 illustrates, with a flow diagram, processing performed by a migration system in accordance with certain embodiments.

FIG. 5 illustrates sample code implemented by a migration system in accordance with certain embodiments.

FIG. 6 illustrates a sample migration Application Programming Interface (API) in accordance with certain embodiments.

FIG. 7 illustrates processing of a received collection in accordance with certain embodiments.

FIG. 8 illustrates a collection with one document having three versions in accordance with certain embodiments.

FIG. 9 illustrates a collection with one document having three versions and document version contents by reference in accordance with certain embodiments.

FIG. 10 illustrates a collection with two documents, each having two versions, in accordance with certain embodiments.

FIG. 11 illustrates a collection with two documents, each having two versions, and document version contents by reference in accordance with certain embodiments.

FIG. 12 illustrates a computer architecture that may be used in accordance with certain embodiments.

### DETAILED DESCRIPTION

In the following description, reference is made to the accompanying drawings which form a part hereof and which illustrate several embodiments of the invention. It is understood that other embodiments may be utilized and structural and operational changes may be made without departing from the scope of the invention.

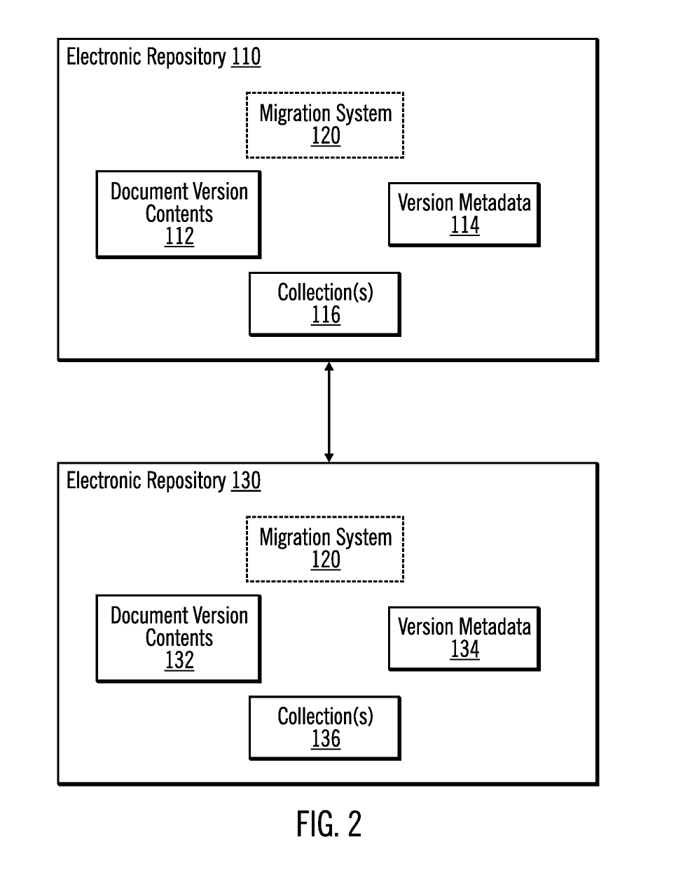

FIG. 2 illustrates a computing architecture in accordance with certain embodiments. An electronic repository 110 is coupled to another electronic repository 130. In certain embodiments, the electronic repositories 110, 130 are different types of electronic repositories (e.g., file system, a Relational DataBase Management System (RDBMS), a document management system or a Content Management System (CMS)). In certain embodiments, the electronic repositories 110, 130 are a same type of electronic repository (e.g., both are CMSs).

A migration system 120 may reside at either or both electronic repositories 110, 130. The electronic repository 110 includes document version contents 112 and version metadata 114. The electronic repository 130 includes document version contents 132 and version metadata 134. Each electronic repository 110, 130 may include, respectively, one or more collections 116, 136 created by the migration system 120. In certain embodiments, the version metadata 114 are stored as records in a Relational DataBase Management System (RDBMS).

The collection 116, 136 represents collected data. The collection 116, 136 may also be referred to as a collection of data, a single unit or a batch. In certain embodiments, the collection 116, 136 is a document. The collection 116, 136 includes indicators that indicate the document version contents and the version metadata associated with a particular document. The collection 116, 136 may include the actual contents of a version or may include a reference to a location of the contents (e.g., a filename).

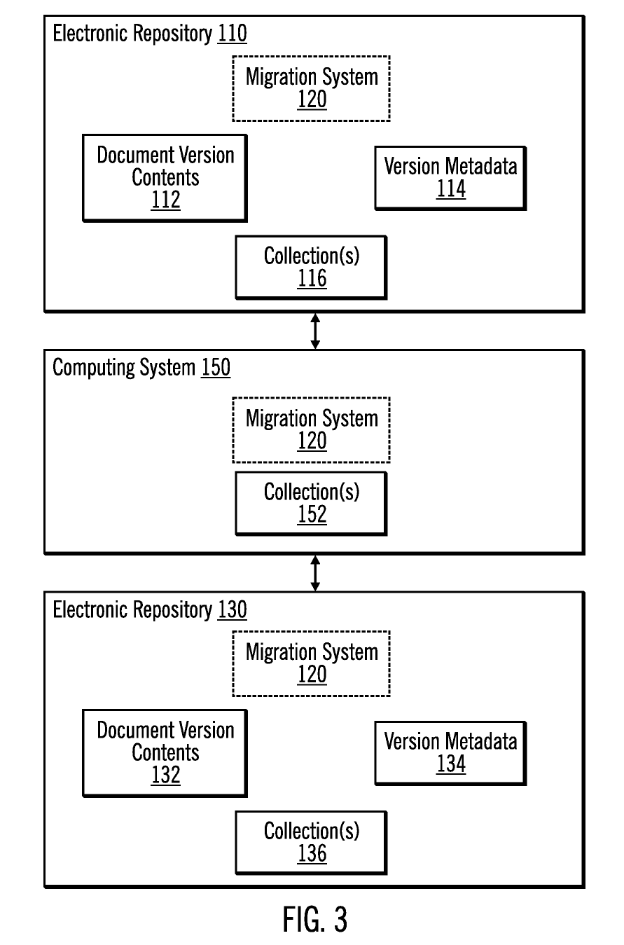

FIG. 3 illustrates another computing architecture in accordance with certain embodiments. The electronic repository 110 is coupled to a computing system 150. The computing system 150 is coupled to the electronic repository 130. In FIG. 3, the computing system 150 includes the migration system 120 and performs the migration of document version contents and version metadata between the electronic repositories 110, 130 by creating one or more collections 152.

Embodiments provide a new migration Application Programming Interface (API) or service endpoint on a destination electronic repository that implements the creation of a document with multiple (e.g., at least two) document version contents and version metadata with a single operation (i.e., as a single step, call or action). A service endpoint is analogous to an API, but used in a different style of programming. Where an API is usually used by most traditional programming languages in a call/return model, a service endpoint is often used in RPC, network, or web style programming in a less structured “do this for me” style of semantics. Either electronic repository 110, 130 may be a destination electronic repository. With this migration API, the migration of document version contents and version metadata is simplified and has improved performance over conventional migration techniques.

In certain embodiments, the migration system 120 at either electronic repository 110, 130 is able to migrate document version contents and version metadata for one document in a collection 116, 136. In certain embodiments, the migration system 120 at either electronic repository 110, 130 is able to migrate document version contents and version metadata for multiple documents in a collection 116, 136. The migration system 120 may migrate documents from the electronic repository 110 to the electronic repository 130 or from the electronic repository 130 to the electronic repository 110.

In certain embodiments, the migration system 120 applies batch processing to the migration of electronic document version contents and version metadata between disparate types of electronic repositories.

The typical uses for batch operations are to package a collection of related or unrelated tasks and request their execution as a collection. The result of executing a batch falls into two categories: 1) when combined with “transaction” semantics, the result will be an “all or nothing” result, such that all of the tasks in the batch must succeed for any of them to succeed, or if any of the tasks in the collection fail, all are considered to have failed, and any work done by any of the individual tasks is “rolled back” or un-done; 2) when not used with transaction semantics, results are typically reported to the requestor as a collection of responses that have a one to one relationship with the original set of tasks, possibly including a summary result such as all succeeded, all failed, or partial success.

In certain embodiments, the migration API receives as input a collection of document version contents in a style that could be, but does not have to be, similar to a batch operation, and the migration API provides the destination electronic repository 110, 130 all of the document version contents and version metadata in a document version history at once, so that the destination electronic repository can re-create the document version history with a single operation (from the requestor's point of view). This enables higher-performance migration capability, and does a better job of recreating a document version history consistent with the original.

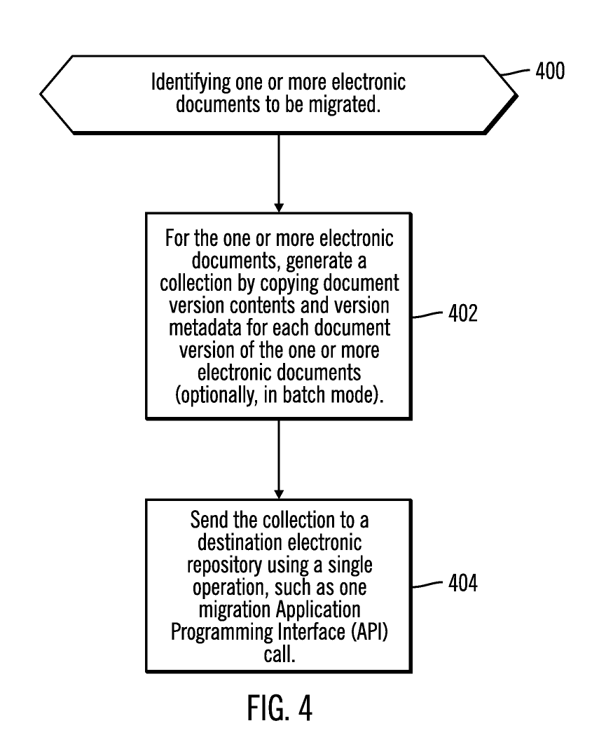

FIG. 4 illustrates, with a flow diagram, processing performed by the migration system 120 in accordance with certain embodiments. Control begins in block 400 with the migration system 120 identifying one or more electronic documents to be migrated. In certain embodiments, the migration system 120 receives a list of documents to be migrated. Receiving the list of documents includes identifying one or more documents to be migrated. In block 402, for the one or more electronic documents, the migration system 120, generates a collection by copying document version contents and version metadata for each document version of the one or more electronic documents into the collection. In certain embodiments, the collection is a single document, and the document version contents and version metadata for each document version is copied into the single document. The single document may be, for example, a word processing document, a web page or any other type of document. Alternatively, the document version contents and version metadata for each document version may be copied into, for example, a file or a segment of memory that is transmitted as one unit. In certain embodiments, the processing of block 402 occurs in batch mode. Batch mode is a term that is broadly applied to the idea of collecting one or more pieces of work and processing them together as if they were a single task. Certain embodiments use such a batch mode.

In block 404, the migration system 120 sends the collection to a destination electronic repository 110, 130 with a single operation. In certain embodiments, the single operation uses one migration API call which results in the activation of one RPC to the destination electronic repository 110, 130.

Thus, RPC traffic on the network joining the electronic repositories 110, 130 is reduced from a number of (“N”) RPCs, as a function of the number of document versions that exist in the document version history of a document, to a single RPC call per document or group of documents regardless of the number of document versions.

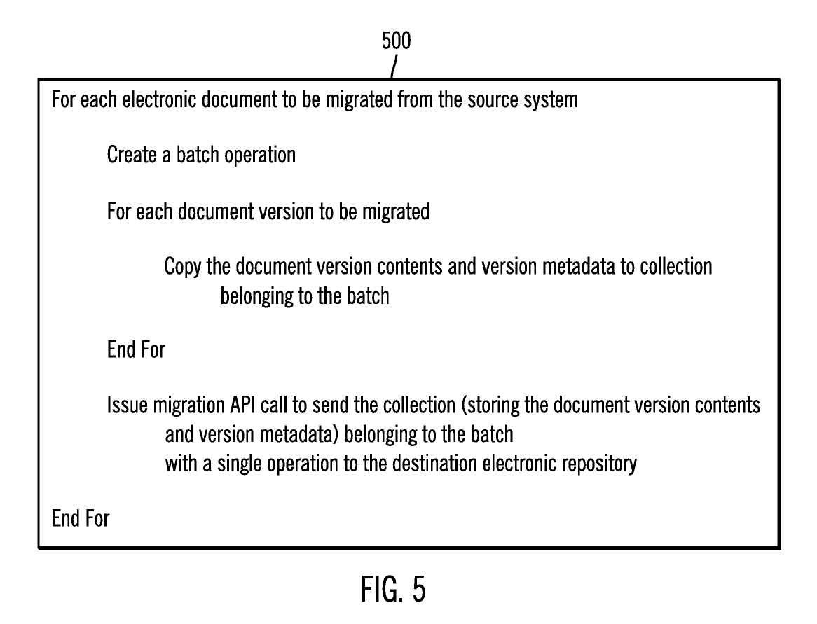

FIG. 5 illustrates sample code 500 implemented by the migration system 120 in accordance with certain embodiments. With reference to the code in FIG. 5, one of the electronic repositories 110, 130 is a source system, and the other of the electronic repositories 110, 130 is a destination electronic repository. For example, with reference to the code in FIG. 5, if three document versions (e.g., Version1, Version2, and Version3) are being migrated, the following processing occurs: the migration system 120 adds the contents of Version1 and the version metadata to the collection 116, 136; the migration system 120 adds the contents of Version2 and the version metadata to the collection 116, 136; and the migration system 120 adds the contents of Version3 and the version metadata to the collection 116, 136. Then, the migration system 120 issues the migration API to send the collection 116, 136 with a single operation to the destination electronic repository 110, 130. Thus, the migration API creates the collection 116, 136 with a document version history containing all the document version contents and version metadata supplied in the collection. An example of batch mode would be to create the collection and to execute the collection of work together. To “execute” a batch may be described as transferring the “data” in the batch to the destination repository and carrying out the “work” defined by the batch. In this context, a batch consists of a collection of data (specifically the contents and the version metadata for document versions), and “work” may be described as explicit or implicit instructions to be carried out using the data in the batch. In certain embodiments, the instructions are high-level operations understood by the electronic repositories as “create version”, “create version history”, etc.

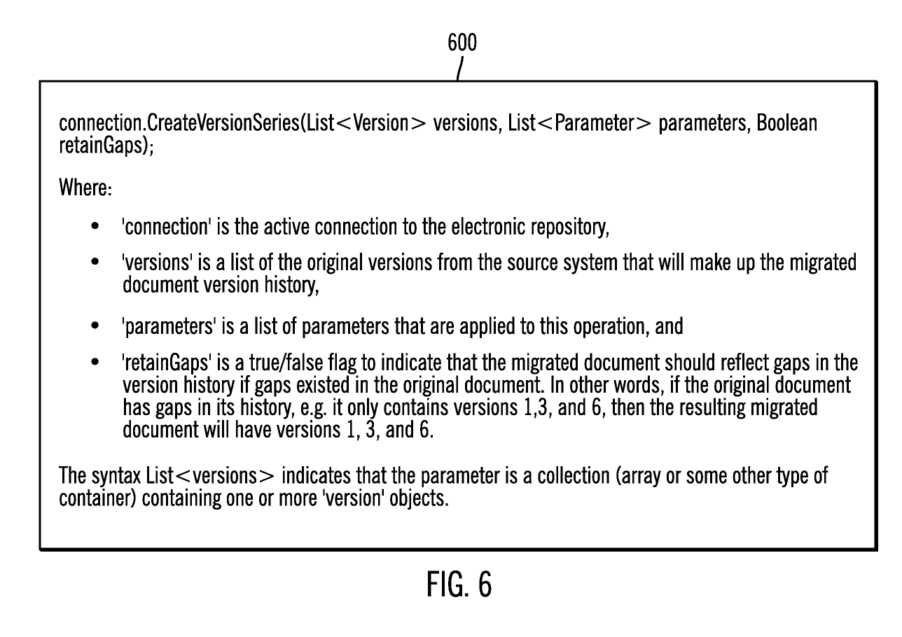

FIG. 6 illustrates a sample migration API 600 in accordance with certain embodiments. With conventional migration techniques, it is difficult to retain gaps as the conventional migration techniques require more operations to create corresponding gaps. On the other hand, the migration API 600 allows setting of a flag “retainGaps” to indicate whether the migrated document should reflect gaps in the document version history if gaps existed in the original document.

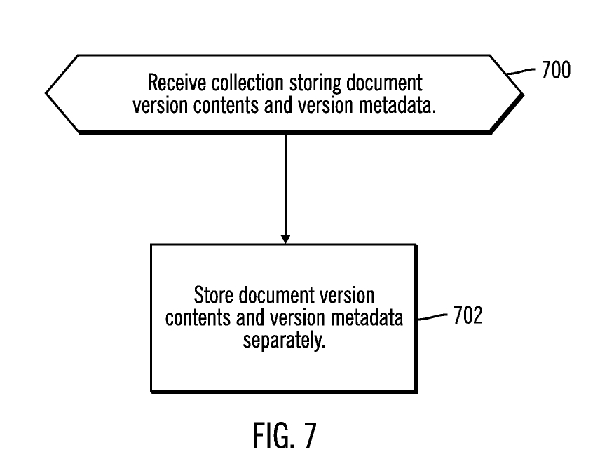

FIG. 7 illustrates processing of a received collection in accordance with certain embodiments. In block 700, the destination electronic repository 110, 130 receives the collection storing the document version contents and version metadata for the one or more documents. In block 702, the destination electronic repository 110, 130 stores the document version contents and version metadata separately.

In certain embodiments, the migration API sends document version contents and version metadata with a single document to the destination electronic repository 110, 130 that implements the creation of a document with multiple versions in a document version history with a single operation.

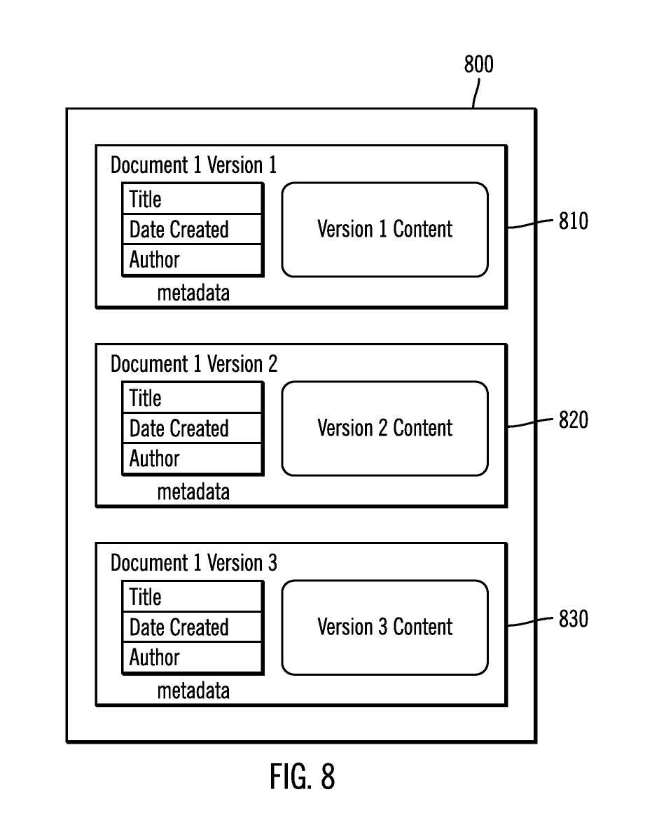

FIG. 8 illustrates a collection 800 with one document having three versions in accordance with certain embodiments. In FIG. 8, the collection 800 includes document version contents and version metadata for a first version 810 of a document, document version contents and version metadata for a second version 820 of the document, and document version contents and version metadata for a third version 830 of the document.

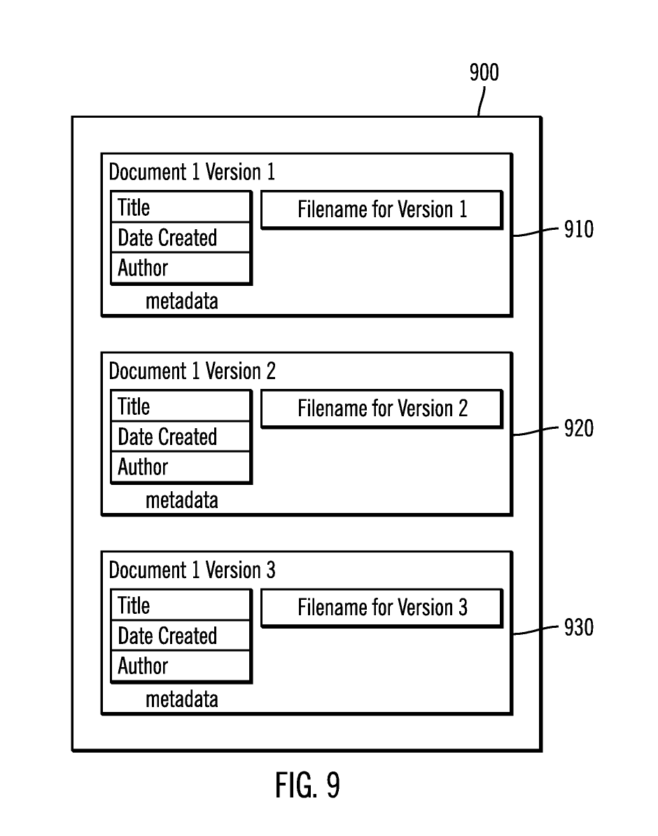

FIG. 9 illustrates a collection 900 with one document having three versions and document version contents by reference in accordance with certain embodiments. Document version contents by reference are stored outside of the collection (e.g., in an external file on disk). In FIG. 9, the collection 900 includes a reference (i.e., a filename) for document version contents and version metadata for a first version 910 of a document, a reference (i.e., a filename) for document version contents and version metadata for a second version 920 of the document, and a reference (i.e., a filename) for document version contents and version metadata for a third version 930 of the document.

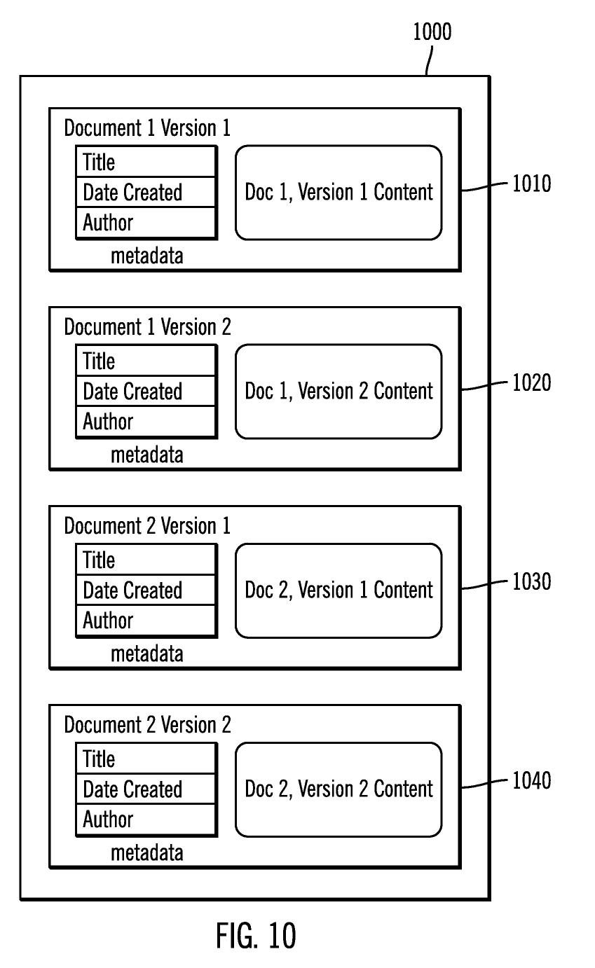

FIG. 10 illustrates a collection 1000 with two documents, each having two versions, in accordance with certain embodiments. In FIG. 10, the collection 1000 includes document version contents and version metadata for a first version 1010 of a first document, document version contents and version metadata for a second version 1020 of the first document, document version contents and version metadata for a first version 1030 of a second document, and document version contents and version metadata for a second version 1040 of the second document.

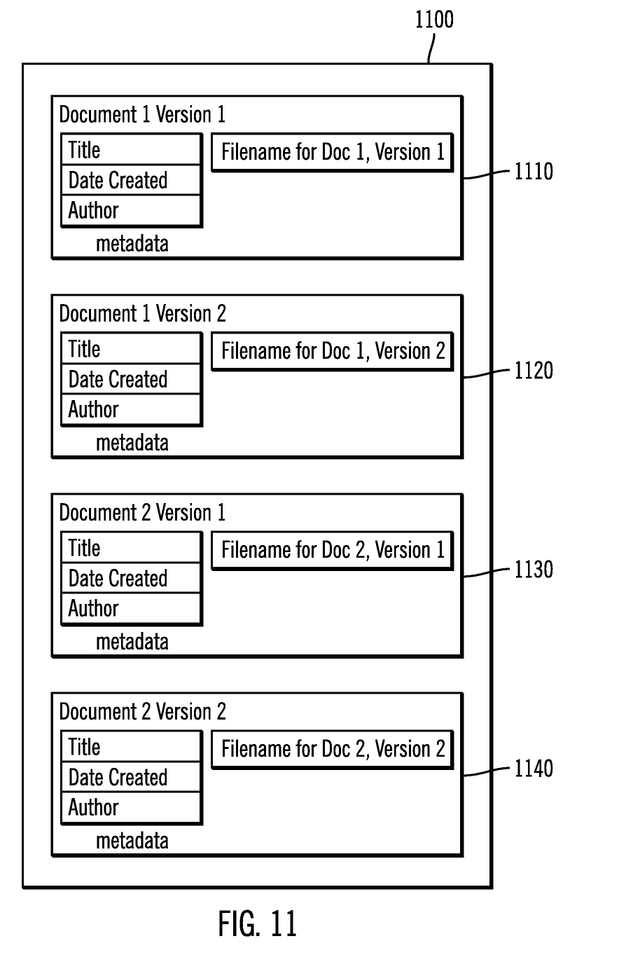

FIG. 11 illustrates a collection 1100 with two documents, each having two versions, and document version contents by reference in accordance with certain embodiments. In FIG. 11, the collection 1100 includes a reference (i.e., a filename) for document version contents and version metadata for a first version 1110 of a first document, a reference (i.e., a filename) for document version contents and version metadata for a second version 1120 of the first document, a reference (i.e., a filename) for document version contents and version metadata for a first version 1130 of a second document, and a reference (i.e., a filename) for document version contents and version metadata for a second version 1140 of the second document.

Federating may be described as a form of migration in which the original contents of the documents remain in the original repository, and only the metadata is migrated to the destination electronic repository 110, 130, along with enough additional metadata to retrieve the contents from the original electronic repository. The migration system 120 is also helpful in accelerating the process of initially federating contents. In certain embodiments, the migration system 120 transmits the version metadata, but not the document version contents, for a document to improve the process of federating documents.

Thus, embodiments improve the performance and integrity of migrating electronic documents and their version metadata from one type of electronic repository 110, 130 to another type of electronic repository 110, 130.

Also, with embodiments, multiple version histories may be included in a single collection. In other words, when migrating the entire version histories of ten documents, all of the document version contents and version metadata are added to the same collection, and the migration API is able to identify the separate versions of the separate documents.

### Additional Embodiment Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, solid state memory, magnetic tape or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The code implementing the described operations may further be implemented in hardware logic or circuitry (e.g., an integrated circuit chip, Programmable Gate Array (PGA), Application Specific Integrated Circuit (ASIC), etc.

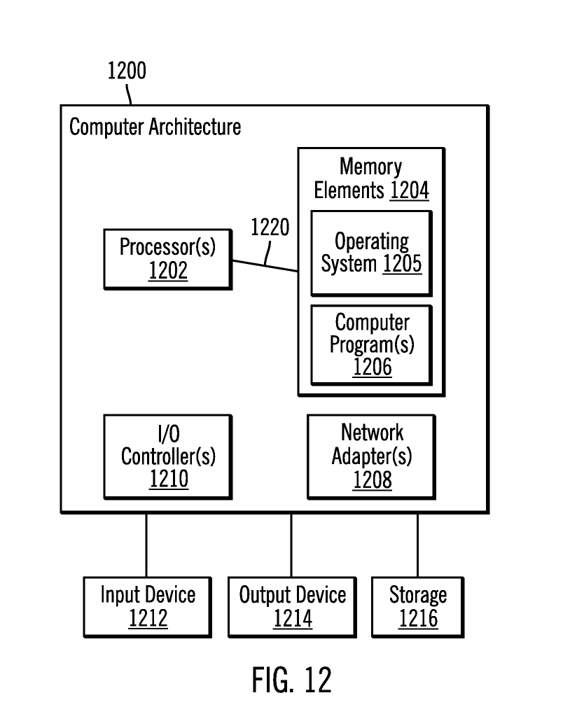

FIG. 12 illustrates a computer architecture 1200 that may be used in accordance with certain embodiments. The electronic repository 110, the electronic repository 130, and/or the computing system 150 may implement computer architecture 1200. The computer architecture 1200 is suitable for storing and/or executing program code and includes at least one processor 1202 coupled directly or indirectly to memory elements 1204 through a system bus 1220. The memory elements 1204 may include local memory employed during actual execution of the program code, bulk storage, and cache memories which provide temporary storage of at least some program code in order to reduce the number of times code must be retrieved from bulk storage during execution. The memory elements 1204 include an operating system 1205 and one or more computer programs 1206.

Input/Output (I/O) devices 1212, 1214 (including but not limited to keyboards, displays, pointing devices, etc.) may be coupled to the system either directly or through intervening I/O controllers 1210.

Network adapters 1208 may also be coupled to the system to enable the data processing system to become coupled to other data processing systems or remote printers or storage devices through intervening private or public networks. Modems, cable modem and Ethernet cards are just a few of the currently available types of network adapters 1208.

The computer architecture 1200 may be coupled to storage 1216 (e.g., a non-volatile storage area, such as magnetic disk drives, optical disk drives, a tape drive, etc.). The storage 1216 may comprise an internal storage device or an attached or network accessible storage. Computer programs 1206 in storage 1216 may be loaded into the memory elements 1204 and executed by a processor 1202 in a manner known in the art.

The computer architecture 1200 may include fewer components than illustrated, additional components not illustrated herein, or some combination of the components illustrated and additional components. The computer architecture 1200 may comprise any computing device known in the art, such as a mainframe, server, personal computer, workstation, laptop, handheld computer, telephony device, network appliance, virtualization device, storage controller, etc.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The foregoing description of embodiments of the invention has been presented for the purposes of illustration and description. It is not intended to be exhaustive or to limit the embodiments to the precise form disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments may be made without departing from the spirit and scope of the embodiments, the embodiments reside in the claims hereinafter appended or any subsequently-filed claims, and their equivalents.

1. A computer-implemented method, comprising:
identifying an electronic document having at least two document versions to be migrated;
copying document version contents and version metadata of each of the at least two document versions into a collection for transmission to a destination electronic repository; and
sending the collection using a migration Application Programming Interface (API) call to the destination electronic repository with a single operation.

2. The method of claim 1, wherein the migration API call results in activation of one Remote Procedure Call (RPC) to the destination electronic repository.

3. The method of claim 1, further comprising:
generating the collection in batch mode.

4. The method of claim 1, further comprising:
receiving the collection at the destination electronic repository; and
storing the document version contents and the version metadata separately.

5. The method of claim 1, further comprising:
identifying at least two electronic documents to be migrated; and
copying the document version contents and the version metadata of at least two document versions of each of the at least two electronic documents into the collection for transmission to the destination electronic repository.

6. A system, comprising:
hardware logic performing operations, the operations comprising:
identifying an electronic document having at least two document versions to be migrated;
copying document version contents and version metadata of each of the at least two document versions into a collection for transmission to a destination electronic repository; and
sending the collection using a migration Application Programming Interface (API) call to the destination electronic repository with a single operation.

7. The system of claim 6, wherein the migration API call results in activation of one Remote Procedure Call (RPC) to the destination electronic repository.

8. The system of claim 6, wherein the operations further comprise:
generating the collection in batch mode.

9. The system of claim 6, wherein the operations further comprise:
receiving the collection at the destination electronic repository; and
storing the document version contents and the version metadata separately.

10. The system of claim 6, wherein the operations further comprise:
identifying at least two electronic documents to be migrated; and
copying the document version contents and the version metadata of at least two document versions of each of the at least two electronic documents into the collection for transmission to the destination electronic repository.

11. A computer program product comprising a computer readable storage medium including a computer readable program, wherein the computer readable program when executed by a processor on a computer causes the computer to:
identify an electronic document having at least two document versions to be migrated;
copy document version contents and version metadata of each of the at least two document versions into a collection for transmission to a destination electronic repository; and
send the collection using a migration Application Programming Interface (API) call to the destination electronic repository with a single operation.

12. The computer program product of claim 11, wherein the migration API call results in activation of one Remote Procedure Call (RPC) to the destination electronic repository.

13. The computer program product of claim 11, wherein the computer readable program when executed by the processor on the computer causes the computer to:
generate the collection in batch mode.

14. The computer program product of claim 11, wherein the computer readable program when executed by the processor on the computer causes the computer to:
receive the collection at the destination electronic repository; and
store the document version contents and the version metadata separately.

15. The computer program product of claim 11, wherein the computer readable program when executed by the processor on the computer causes the computer to:
identify at least two electronic documents to be migrated; and
copy the document version contents and the version metadata of at least two document versions of each of the at least two electronic documents into the collection for transmission to the destination electronic repository.
